(19) United States
(12) Patent Application Publication
(10) Pub. No.: US 2022/0019856 A1
(43) Pub. Date: Jan. 20, 2022

(54) PREDICTING NEURAL NETWORK PERFORMANCE USING NEURAL NETWORK GAUSSIAN PROCESS

(71) Applicant: Google LLC, Mountain View, CA (US)

(72) Inventors: Jaehoon Lee, Palo Alto, CA (US); Daiyi Peng, Cupertino, CA (US); Yuan Cao, Mountain View, CA (US); Jascha Narain Sohl-Dickstein, San Francisco, CA (US); Daniel Sung-Joon Park, Sunnyvale, CA (US)

(21) Appl. No.: 17/377,142

(22) Filed: Jul. 15, 2021

Related U.S. Application Data
(60) Provisional application No. 63/052,045, filed on Jul. 15, 2020.

(51) Int. Cl. G06K 9/62; G06N 3/08

(52) U.S. Cl. CPC G06K 9/6262; G06N 3/08; G06K 9/623

(57) ABSTRACT

A method for predicting performance of a neural network (NN) is described. The method includes receiving a training data set having a set of training samples; receiving a validation data set having a set of validation pairs; initializing (i) a validation-training kernel matrix representing similarities of the validation inputs in the validation data set and the training inputs in the training data set and (ii) a training-training kernel matrix representing similarities across the training inputs within the training data set; generating a final updated validation-training kernel matrix and a final updated training-training kernel matrix; performing the following operations at least once: generating predicted validation outputs for the validation inputs, and updating an accuracy score of the NN based on the predicted validation outputs and the validation outputs; and outputting the updated accuracy score as a final accuracy score representing performance of the NN.

### CROSS REFERENCE TO RELATED APPLICATIONS

This application is a non-provisional of and claims priority to U.S. Provisional Patent Application No. 63/052,045, filed on Jul. 15, 2020, the entire contents of which are hereby incorporated by reference.

### BACKGROUND

This specification relates to predicting performance of a neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that predicts an accuracy score that represents performance of a neural network without training the neural network. The neural network is one of multiple candidate neural networks for performing a neural network task that requires generating network outputs for network inputs. The system can use the accuracy score of the neural network to select a final neural network from the multiple candidate neural networks for performing the neural network task.

The subject matter described in this specification can be implemented in particular embodiments so as to realize one or more of the following advantages.

Accurately predicting the performance of a neural network on a task is extremely computationally expensive and the most reliable way of doing so is training the neural network to completion. In conventional neural architecture search methods, the performance of a large number of neural networks in the search space must be evaluated. The described techniques provide an inexpensive measure indicative of the final performance of a neural network without training the neural network (e.g., without using gradient-based learning), therefore reducing the computational cost of neural architecture search.

In particular, the described techniques compute “Neural Network Gaussian Process (NNGP) validation accuracy” (or an “accuracy score”) and use it as a computationally inexpensive quantity to predict the neural network's actual performance on a neural network task without training the neural network. This NNGP validation accuracy is obtained by computing a NNGP kernel of the neural network (by repeatedly reinitializing the parameters of the network based on an initialization distribution of the parameters) and performing Gaussian inference on a validation set using the constructed kernel. Compared to gradient-based measures, the NNGP validation accuracy has the following technical advantages:
It is orders of magnitude cheaper in terms of computational resources (e.g., memory, processing power, etc.) and wall clock processing time than to compute gradient-based performance predictions.
The overall ranking coming from NNGP validation accuracy is comparable to gradient-based performance predictions.
NNGP validation accuracy is better than very expensive gradient-based performance predictions at predicting whether a neural network has above-median performance.
The NNGP validation accuracy can be used as a signal complementary to gradient-based training, as NNGP performance is obtained without using any gradient-based training, or past gradient-based training data. That means, the NNGP validation accuracy can augment gradient-based performance measures to improve their predictive quality.

Further, by reducing computational costs of evaluating neural network performance and neural architecture search, the described techniques would lead to a reduction of the footprint, i.e., in terms of processing power and energy consumption, of deep learning research and applications.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for generating predicted validation outputs.

FIG. 3 is a flow diagram of an example process for predicting performance of a neural network.

Like reference numbers and designations in the various drawings indicate like elements.

### DETAILED DESCRIPTION

This specification describes a system implemented as computer programs on one or more computers in one or more locations that predicts an accuracy score that represents the performance of a neural network without training the neural network. The neural network is one of multiple candidate neural networks for performing a neural network task that requires generating network outputs for network inputs. The system can use the accuracy score of the neural network to select a final neural network from the multiple candidate neural networks for performing the neural network task.

The neural network can be configured to perform any kind of neural network tasks, i.e., can be configured to receive any kind of digital data input and to generate any kind of score, classification, or regression output based on the input.

In some cases, the neural network is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language. As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

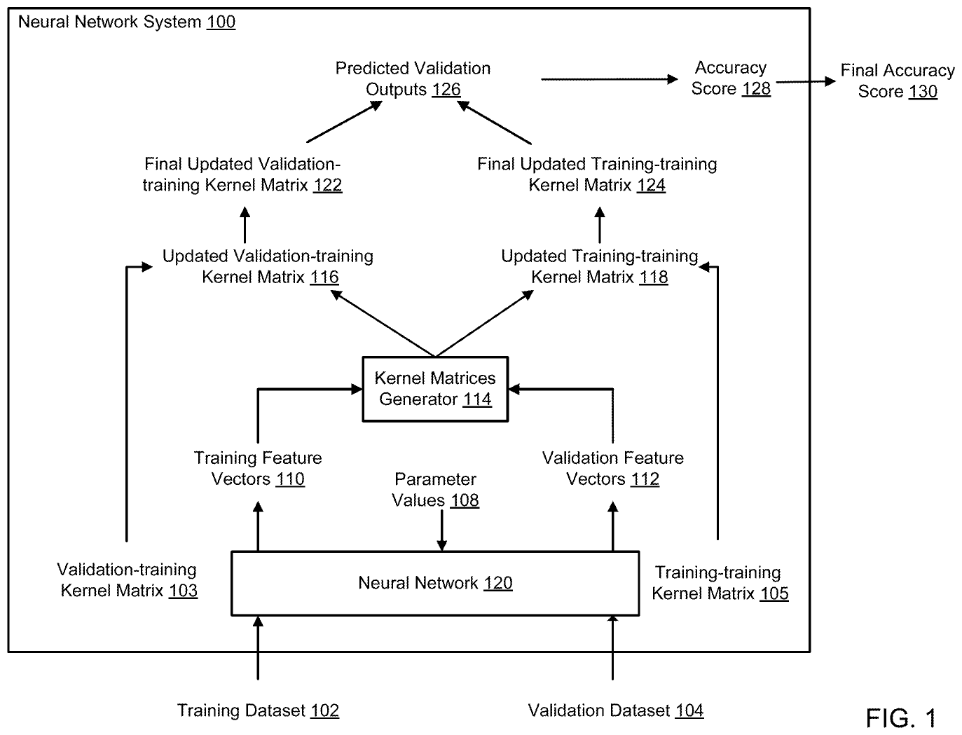

FIG. 1 shows an example neural network system. The system 100 is an example of a system implemented as computer programs on one or more computers in one or more locations, in which the systems, components, and techniques described below can be implemented.

The system 100 is configured to predict performance of a neural network 120. In particular, the system 100 computes a “Neural Network Gaussian Process (NNGP) validation accuracy” (or an “accuracy score”), denoted as Aᵥₐₗ, and use it as a computationally inexpensive quantity to predict the neural network 120's actual performance on a neural network task without training the neural network 120.

To predict performance of the neural network 120 without training it, the system 100 receives a training data set 102 having a set of training samples. Each of the training samples has a training input xᵢ and a corresponding training output yⁱ. The system 100 receives a validation data set 104 having a set of validation pairs. Each of the validation pairs has a validation input denoted as x̅^{a} and a corresponding validation output denoted as Īₐ.

The neural network 120 can have any appropriate architecture that allows the network 120 to map an input x into a feature vector z, followed by one or more output layers, e.g., a linear readout layer, to produce a predicted output for the input x.

For example, the neural network 120 can be denoted as f( ) and can have a set of network parameters θ. The neural network 120 can be configured to map an input x into a feature vector \tilde{z}=f(x, θ) of dimension d, followed by a linear readout layer with weight variance σ_{w}² producing predicted outputs \tilde{y} for the input x. Consider n inputs x¹, x², . . . , xⁿ. In the NNGP approximation, the distribution over possible outputs \tilde{y}_{I}¹, . . . , \tilde{y}_{I}ⁿ for any label I at initialization is jointly Gaussian,

$$( {\tilde{y}}_{I}^{1} , ⋯ , {\tilde{y}}_{I}^{n} ) ∼ 𝒩 ( 0 , {σ}_{w}^{2} K ) , {K}_{ij} = K ( {x}^{i} , {x}^{j} ) = {𝔼}_{0} [ \frac{1}{d} {\sum }_{k = 1}^{d} {\tilde{z}}_{k}^{i} {\tilde{z}}_{k}^{j} ] , \qquad ( 1 )$$

where I denotes an index of a classification label. For example, for a digit classification task, the index I goes from 0 to 9. Thus, for a given input x, the neural network 120 generates ten output vectors \tilde{y}₀, \tilde{y}₁, . . . , \tilde{y}₉.

In Eq. (1), K(xⁱ, x^{j}) is a sample-sample second moment of \tilde{z} averaged over random network initializations. More specifically, a sample-sample second moment means that the indices i, j are sample indices, and that the moment is second-order, i.e., quadratic in the values of \tilde{z}. Eq. (1) is used to compute an average over the θ variable and the k variable. As mentioned above, \tilde{z} is a d-dimensional vector (i.e., k=1, 2, . . . , d), which is a function of the input x and the network parameters θ. First, a sum over the k index and divide by dimension d is computed, i.e., the sum is

$$[ \frac{1}{d} {\sum }_{k = 1}^{d} {\tilde{z}}_{k}^{i} {\tilde{z}}_{k}^{j} ] .$$

The obtained result is then averaged over the initialization distribution of the network parameters θ. That means (and as described in more detail below) the network parameters θ is re-initialized n_{ensemble} times (i.e., by sampling a set of parameter values for the set of network parameters θ from an initialization distribution p(θ) each time) and the obtained result is averaged over these θ values.

The system 100 initializes a validation-training kernel matrix 103 that represents similarities of the validation inputs in the validation data set 104 and the training inputs in the training data set 102. The validation-training kernel matrix 103, denoted as K^{vt}, is a two-dimensional matrix having a number of rows equal to the number of validation pairs in the validation data set and a number of columns equal to the number of training samples in the training data set. In some implementations, the system 100 may initialize the validation-training kernel matrix 103 with a first zero matrix, i.e., K^{vt}=0_{N}_{ᵥₐₗ}_{×N}_{ₜᵣₐᵢₙ}, where Nᵥₐₗ is the number of validation pairs in the validation data set 104, and Nₜᵣₐᵢₙ is the number of training samples in the training data set 102.

The system 100 initializes a training-training kernel matrix 105 that represents similarities across the training inputs within the training data set 102. The training-training kernel matrix 105, denoted as K^{tt}, is a two-dimensional square matrix in which the number of rows/columns equals to the number of training samples in the training data set 102. The system 100 may initialize the training-training kernel matrix 105 with a second zero matrix. For example, the matrix 105 can be initialized as follows: K^{tt}=0_{N}_{ᵥₐₗ}_{×N}_{ₜᵣₐᵢₙ}.

The system 100 initializes an accuracy score 128 of the neural network 120. For example, the system 100 may initialize the accuracy score 128 as zero, i.e., Aᵥₐₗ=0. As another example, the system 100 may initialize the accuracy score 128 using a predetermined value.

The system 100 generates a final updated validation-training kernel matrix and a final updated training-training kernel matrix by performing n_{ensemble} steps as follows.

At each of n_{ensemble} steps, the system 100 samples a set of parameter values 108 for the set of network parameters θ from an initialization distribution p(θ). The system 100 can receive the initialization distribution p as part of the input to the system 100. The initialization distribution p can be, for example, a uniform distribution or a Gaussian distribution.

The system 100 then generates, from the training inputs, training feature vectors 110 using the neural network 120 in accordance with the sampled parameter values of the network parameters. In particular, for each training input i ∈ [0, Nₜᵣₐᵢₙ], the system 100 generates a respective training feature vector zᵢ=f(xⁱ; θ) by processing the training input using the neural network with the neural network having the sampled parameter values.

The system 100 generates, from the validation inputs, validation feature vectors 112 using the neural network 120 in accordance with the sampled parameter values 108 of the network parameters. In particular, for each validation input a ∈ [0, Nᵥₐₗ], the system 100 generates a respective validation feature vector z̅ₐ=f(x̅^{a}; θ) by processing the validation input using the neural network with the neural network having the sampled parameter values.

The system 100 uses a kernel matrices generator 114 to update the validation-training kernel matrix 103 and the training-training kernel matrix 105 using the validation feature vectors 110 and the training feature vectors 112.

In particular, the kernel matrices generator 114 updates the validation-training kernel matrix 103 using the validation feature vectors 112 and the training feature vectors 110. The kernel matrices generator 114 generates an update for each of a plurality of elements of the validation-training kernel matrix 103 based on a dot product of a respective validation feature vector and a respective training feature vector. For example, for each element (a, i) ∈ [0, Nᵥₐₗ)×[0, Nₜᵣₐᵢₙ), the generator 114 generates an update by adding

$$\frac{1}{{n}_{ensemble} d} {\overline{z}}_{a} \cdot {z}_{i}$$

to Kₐᵢ^{vt}. The generator 114 combines the updates for all elements of the matrix 103 to generate an updated validation-training kernel matrix 116 for each of the n_{ensemble} steps.

The system 100 uses the kernel matrices generator 114 to update the training-training kernel matrix 105 based on the training feature vectors 110. The kernel matrices generator 114 generates an update for each of a plurality of elements of the training-training kernel matrix 105 based on a dot product of a respective first training feature vector and a respective second training feature vector.

In particular, the generator 114 updates the training-training kernel matrix 105 by, for each element (i, j) ∈ [0, Nₜᵣₐᵢₙ)², adding

$$\frac{1}{{n}_{ensemble} d} {z}_{i} \cdot {z}_{j}$$

to Kᵢⱼ^{tt}. The updates for all elements of the matrix 105 result in an updated training-training kernel matrix 118 for each of the n_{ensemble} steps.

After performing n_{ensemble} steps above, the system 100 obtains a final updated validation-training kernel matrix 122 and a final updated training-training kernel matrix 124.

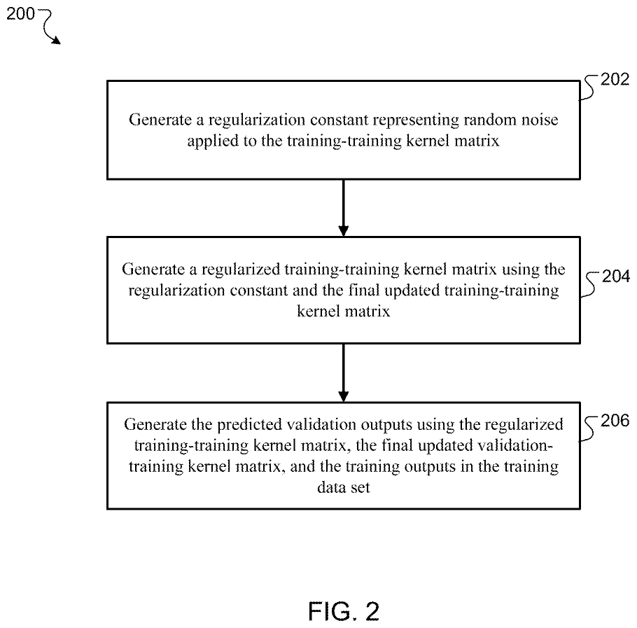

The system 100 generates predicted validation outputs 126, denoted as Y_{aI}, for the validation inputs using the final updated training-training kernel matrix 122, the final updated validation-training kernel matrix 124, and the training outputs in the training data set 102. The process for generating the predicted validation outputs 126 is described in more detail below with reference to FIG. 2.

The system 100 updates the accuracy score 128 of the neural network 120 based on the predicted validation outputs 126 and the validation outputs in the validation data set 104. As mentioned above, the accuracy score 128 could be initialized, for example, as zero.

In particular, to update the accuracy score 128, the system 100 generates a candidate updated accuracy score based on a number of correctly predicted validation outputs. For example, the candidate updated accuracy score can be generated as follows:

Cᵥₐₗ=Σₐ(Ī^{a}==arg maxₗY_{aI})

The system 100 then generates the updated accuracy score based on the current accuracy score and the candidate updated accuracy score, for example, by selecting the maximum of (i) the current accuracy score and (ii) the candidate updated accuracy score divided by the number of validation pairs in the validation data set 104 as follows:

Aᵥₐₗ=max(Aᵥₐₗ,Cᵥₐₗ/Nᵥₐₗ)

The system 100 can repeatedly generate new predicted validation outputs 126 and update the accuracy score 128 for each regularization constant \tilde{ϵ} ∈ [\tilde{ϵ}₁, . . . , \tilde{ϵ}ᵣ].

The system 100 outputs the updated accuracy score obtained after these iterations as a final accuracy score 130 that represents performance of the neural network 120.

In some implementations, the neural network 120 is one of multiple candidate neural networks generated during performance of a neural architecture search technique, which aims to find a neural network for performing a neural network task.

The system can use the final accuracy score of the neural network 120 to select a final neural network from the multiple candidate neural networks for performing the neural network task.

The final accuracy score, which is referred to as a NNGP validation accuracy, could be used in combination with other network performance evaluation techniques. For example, the NNGP validation accuracy can be used as a signal complementary to gradient-based training, as the NNGP performance is obtained without using any gradient-based training, or past gradient-based training data. That means, the NNGP validation accuracy can augment gradient-based performance measures to improve their predictive quality.

FIG. 2 is a flow diagram of an example process 200 for generating predicted validation outputs. For convenience, the process 200 will be described as being performed by a system of one or more computers located in one or more locations. For example, a neural network system, e.g., the neural network system 100 of FIG. 1, appropriately programmed in accordance with this specification, can perform the process 200.

The system generates a regularization constant representing random noise applied to the training-training kernel matrix (step 202). The regularization constant, denoted as \tilde{ϵ}, can be selected from a set of r constants [\tilde{ϵ}₁, . . . , \tilde{ϵ}ᵣ].

The system generates a regularized training-training kernel matrix using the regularization constant and the final updated training-training kernel matrix (step 204).

For example, the regularized training-training kernel matrix can be computed as follows:

K^{tt}+\tilde{ϵ}λ1_{N}_{ₜᵣₐᵢₙ},

where λ is determined based on the number of training samples in the training dataset 102 and on the training-training kernel matrix 105. For example, λ can be computed by

$$λ = \frac{1}{{N}_{train}} Tr ( {K}^{tt} ) ,$$

where Tr(K^{tt}) is the trace of the training-training kernel matrix 105.

The system generates the predicted validation outputs using the regularized training-training kernel matrix, the final updated validation-training kernel matrix, and the training outputs in the training data set (step 206). For example, the predicted validation outputs can be denoted as Y_{aI} and can be computed as follows:

Y_{aI}=Σ_{i,j}Kₐᵢ^{vt}(K^{tt}+\tilde{ϵ}λ1_{N}_{ₜᵣₐᵢₙ})ᵢⱼ⁻¹y_{I}^{j}

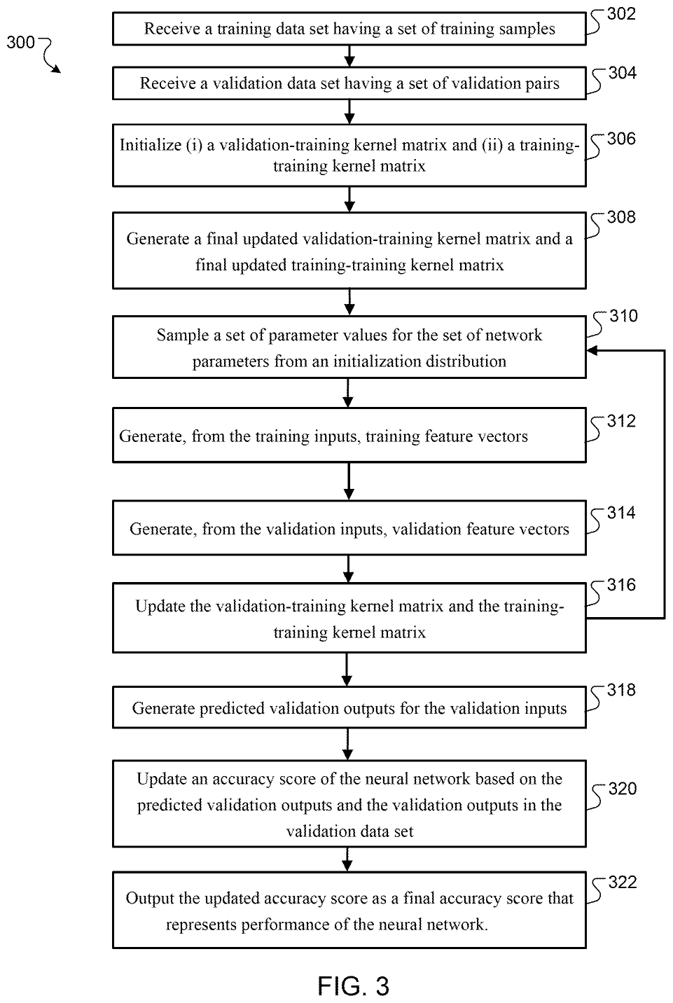

FIG. 3 is a flow diagram of an example process for predicting performance of a neural network. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The neural network is configured to receive a given input and to process the given input to generate a corresponding feature vector having a dimension d for the given input. The neural network includes an output layer configured to process the corresponding feature vector to generate a corresponding output for the given input. The neural network is configured to generate the corresponding output based on a probability distribution of possible outputs (e.g., the Gaussian distribution defined by Eq. (1)) by selecting a possible output having the largest probability as the corresponding output.

The system receives a training data set having a set of training samples, each of the training samples having a training input and a corresponding training output (step 302).

The system receives a validation data set having a set of validation pairs, each of the validation pairs having a validation input and a corresponding validation output (step 304). The system initializes (i) a validation-training kernel matrix representing similarities of the validation inputs in the validation data set and the training inputs in the training data set and (ii) a training-training kernel matrix representing similarities across the training inputs within the training data set (step 306). The validation-training kernel matrix is a two-dimensional matrix having a number of rows equal to the number of validation pairs in the validation data set and a number of columns equal to the number of training samples in the training data set. Initializing the validation-training kernel matrix may include initializing the validation-training kernel matrix with a first zero matrix. The training-training kernel matrix is a two-dimensional square matrix in which the number of rows equals to the number of training samples in the training data set. Initializing the training-training kernel matrix comprises initializing the training-training kernel matrix with a second zero matrix.

The system generates a final updated validation-training kernel matrix and a final updated training-training kernel matrix (308). The generating includes, at each of N steps, performing steps 310-316 as follows.

The system samples a set of parameter values for the set of network parameters from an initialization distribution (step 310).

The system generates, from the training inputs, training feature vectors using the feature extraction neural network in accordance with the sampled parameter values of the network parameters (step 312).

The system generates, from the validation inputs, validation feature vectors using the feature extraction neural network in accordance with the sampled parameter values of the network parameters (step 314).

The system updates the validation-training kernel matrix and the training-training kernel matrix using the validation feature vectors and the training feature vectors (step 316). In particular, the system updates the validation-training kernel matrix using the validation feature vectors and the training feature vectors, and updates the training-training kernel matrix using the training feature vectors.

To update the validation-training kernel matrix, the system generates an update for each of a plurality of elements of the validation-training kernel matrix based on a dot product of a respective validation feature vector and a respective training feature vector.

To update the training-training kernel matrix, the system generates an update for each of a plurality of elements of the training-training kernel matrix based on a dot product of a respective first training feature vector and a respective second training feature vector. The system performs steps 318 and 320 below at least once.

The system generates predicted validation outputs for the validation inputs using the final updated training-training kernel matrix, the final updated validation-training kernel matrix, and the training outputs in the training data set (step 318). In particular, the system generates a regularization constant representing random noise applied to the training-training kernel matrix. The system generates a regularized training-training kernel matrix using the regularization constant and the final updated training-training kernel matrix. The system generates the predicted validation outputs using the regularized training-training kernel matrix, the final updated validation-training kernel matrix, and the training outputs in the training data set.

The system updates an accuracy score of the neural network based on the predicted validation outputs and the validation outputs in the validation data set (step 320). In particular, the system generates a candidate updated accuracy score based on a number of correctly predicted validation outputs, and generates the updated accuracy score by selecting the maximum of (i) the current accuracy score and (ii) the candidate updated accuracy score divided by the number of validation pairs in the validation data set.

The system outputs the updated accuracy score as a final accuracy score that represents performance of the neural network (step 322).

In some implementations, the neural network is one of a plurality of candidate neural networks for performing a neural network task that requires generating network outputs for network inputs. In these implementations, the system can use the final accuracy score of the neural network to select a final neural network from the plurality of candidate neural networks for performing the neural network task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for predicting performance of a neural network, wherein the neural network has a set of network parameters, the method comprising:
receiving a training data set having a set of training samples, each of the training samples having a training input and a corresponding training output;
receiving a validation data set having a set of validation pairs, each of the validation pairs having a validation input and a corresponding validation output;
initializing (i) a validation-training kernel matrix representing similarities of the validation inputs in the validation data set and the training inputs in the training data set and (ii) a training-training kernel matrix representing similarities across the training inputs within the training data set;
generating a final updated validation-training kernel matrix and a final updated training-training kernel matrix, the generating comprising, at each of N steps:
sampling a set of parameter values for the set of network parameters from an initialization distribution,
generating, from the training inputs, training feature vectors using the neural network in accordance with the sampled parameter values of the network parameters,
generating, from the validation inputs, validation feature vectors using the neural network in accordance with the sampled parameter values of the network parameters, and
updating the validation-training kernel matrix and the training-training kernel matrix using the validation feature vectors and the training feature vectors;
performing the following operations at least once:
generating predicted validation outputs for the validation inputs using the final updated training-training kernel matrix, the final updated validation-training kernel matrix, and the training outputs in the training data set, and
updating an accuracy score of the neural network based on the predicted validation outputs and the validation outputs in the validation data set; and
outputting the updated accuracy score as a final accuracy score that represents performance of the neural network.

2. The method of claim 1, wherein the neural network is configured to receive a given input and to process the given input to generate a corresponding feature vector having a dimension d for the given input, and wherein the neural network comprises an output layer configured to process the corresponding feature vector to generate a corresponding output for the given input.

3. The method of claim 2, wherein the neural network is configured to generate the corresponding output based on a probability distribution of possible outputs by selecting a possible output having the largest probability as the corresponding output.

4. The method of claim 1, wherein the validation-training kernel matrix is a two-dimensional matrix having a number of rows equals to the number of validation pairs in the validation data set and a number of columns equals to the number of training samples in the training data set.

5. The method of claim 1, wherein initializing the validation-training kernel matrix comprises initializing the validation-training kernel matrix with a first zero matrix.

6. The method of claim 1, wherein the training-training kernel matrix is a two-dimensional square matrix in which the number of rows equals to the number of training samples in the training data set.

7. The method of claim 1, wherein initializing the training-training kernel matrix comprises initializing the training-training kernel matrix with a second zero matrix.

8. The method of claim 1, wherein generating, from the training inputs and the validation inputs, the training feature vectors and the validation feature vectors comprises:
generating, for each training input, a respective training feature vector using the neural network in accordance with the sampled values of the network parameters, and
generating, for each validation input, a respective validation feature vector using the neural network in accordance with the sampled values of the network parameters.

9. The method of claim 1, wherein updating the validation-training kernel matrix and the training-training kernel matrix using the validation feature vectors and the training feature vectors comprises:
updating the validation-training kernel matrix using the validation feature vectors and the training feature vectors, and
updating the training-training kernel matrix using the training feature vectors.

10. The method of claim 9, wherein updating the validation-training kernel matrix using the validation feature vectors and the training feature vectors comprises:
generating an update for each of a plurality of elements of the validation-training kernel matrix based on a dot product of a respective validation feature vector and a respective training feature vector.

11. The method of claim 9, wherein updating the training-training kernel matrix using the training feature vectors comprises:
generating an update for each of a plurality of elements of the training-training kernel matrix based on a dot product of a respective first training feature vector and a respective second training feature vector.

12. The method of claim 1, wherein generating the predicted validation outputs using the final updated training-training kernel matrix, the final updated validation-training kernel matrix, and the training outputs in the training data set comprises:
generating a regularization constant representing random noise applied to the training-training kernel matrix,
generating a regularized training-training kernel matrix using the regularization constant and the final updated training-training kernel matrix, and
generating the predicted validation outputs using the regularized training-training kernel matrix, the final updated validation-training kernel matrix, and the training outputs in the training data set.

13. The method of claim 1, wherein updating the accuracy score of the neural network based on the predicted validation outputs and the validation outputs in the validation training data set comprises:
generating a candidate updated accuracy score based on a number of correctly predicted validation outputs, and
generating the updated accuracy score by selecting the maximum of the current accuracy score and the candidate updated accuracy score divided by the number of validation pairs in the validation dataset.

14. The method of claim 1, wherein the neural network is one of a plurality of candidate neural networks for performing a neural network task that requires generating network outputs for network inputs, and wherein the method further comprises:
using the final accuracy score of the neural network to select a final neural network from the plurality of candidate neural networks for performing the neural network task.

15. One or more non-transitory computer storage media encoded with instructions that, when executed by one or more computers, cause the one or more computers to perform operations for predicting performance of a neural network, wherein the neural network has a set of network parameters, the operation comprising:
receiving a training data set having a set of training samples, each of the training samples having a training input and a corresponding training output;
receiving a validation data set having a set of validation pairs, each of the validation pairs having a validation input and a corresponding validation output;
initializing (i) a validation-training kernel matrix representing similarities of the validation inputs in the validation data set and the training inputs in the training data set and (ii) a training-training kernel matrix representing similarities across the training inputs within the training data set;
generating a final updated validation-training kernel matrix and a final updated training-training kernel matrix, the generating comprising, at each of N steps:
sampling a set of parameter values for the set of network parameters from an initialization distribution,
generating, from the training inputs, training feature vectors using the neural network in accordance with the sampled parameter values of the network parameters, generating, from the validation inputs, validation feature vectors using the neural network in accordance with the sampled parameter values of the network parameters, and
updating the validation-training kernel matrix and the training-training kernel matrix using the validation feature vectors and the training feature vectors;
performing the following operations at least once:
generating predicted validation outputs for the validation inputs using the final updated training-training kernel matrix, the final updated validation-training kernel matrix, and the training outputs in the training data set, and
updating an accuracy score of the neural network based on the predicted validation outputs and the validation outputs in the validation data set; and
outputting the updated accuracy score as a final accuracy score that represents performance of the neural network.

16. A system comprising one or more computers and one or more non-transitory computer storage media encoded with instructions that, when executed by the one or more computers, cause the one or more computers to perform operations for predicting performance of a neural network, wherein the neural network has a set of network parameters, the operation comprising:
receiving a training data set having a set of training samples, each of the training samples having a training input and a corresponding training output;
receiving a validation data set having a set of validation pairs, each of the validation pairs having a validation input and a corresponding validation output;
initializing (i) a validation-training kernel matrix representing similarities of the validation inputs in the validation data set and the training inputs in the training data set and (ii) a training-training kernel matrix representing similarities across the training inputs within the training data set;
generating a final updated validation-training kernel matrix and a final updated training-training kernel matrix, the generating comprising, at each of N steps:
sampling a set of parameter values for the set of network parameters from an initialization distribution,
generating, from the training inputs, training feature vectors using the neural network in accordance with the sampled parameter values of the network parameters, generating, from the validation inputs, validation feature vectors using the neural network in accordance with the sampled parameter values of the network parameters, and
updating the validation-training kernel matrix and the training-training kernel matrix using the validation feature vectors and the training feature vectors;
performing the following operations at least once:
generating predicted validation outputs for the validation inputs using the final updated training-training kernel matrix, the final updated validation-training kernel matrix, and the training outputs in the training data set, and
updating an accuracy score of the neural network based on the predicted validation outputs and the validation outputs in the validation data set; and
outputting the updated accuracy score as a final accuracy score that represents performance of the neural network.

17. The system of claim 16, wherein the operations for generating, from the training inputs and the validation inputs, the training feature vectors and the validation feature vectors comprise:
generating, for each training input, a respective training feature vector using the feature extraction neural network in accordance with the sampled values of the network parameters, and
generating, for each validation input, a respective validation feature vector using the feature extraction neural network in accordance with the sampled values of the network parameters.

18. The system of claim 16, wherein the operations for updating the validation-training kernel matrix and the training-training kernel matrix using the validation feature vectors and the training feature vectors comprise:
updating the validation-training kernel matrix using the validation feature vectors and the training feature vectors, and
updating the training-training kernel matrix using the training feature vectors.

19. The system of claim 16, wherein the operations for generating the predicted validation outputs using the final updated training-training kernel matrix, the final updated validation-training kernel matrix, and the training outputs in the training data set comprise:
generating a regularization constant representing random noise applied to the training-training kernel matrix,
generating a regularized training-training kernel matrix using the regularization constant and the final updated training-training kernel matrix, and
generating the predicted validation outputs using the regularized training-training kernel matrix, the final updated validation-training kernel matrix, and the training outputs in the training data set.

20. The system of claim 16, wherein the operations for updating the accuracy score of the neural network based on the predicted validation outputs and the validation outputs in the validation training data set comprise:
generating a candidate updated accuracy score based on a number of correctly predicted validation outputs, and
generating the updated accuracy score by selecting the maximum of the current accuracy score and the candidate updated accuracy score divided by the number of validation pairs in the validation dataset.
